(19) United States
(12) Patent Application Publication
(10) Pub. No.: US 2026/0021621 A1
(43) Pub. Date: Jan. 22, 2026

(54) ANNULAR MICROLAYER FEEDBLOCK

(71) Applicant: Guill Tool & Engineering Co., Inc., West Warwick, RI (US)

(72) Inventors: Robert Peters, East Greenwich, RI (US); Denis Finn, JR., Wrentham, MA (US)

(73) Assignee: Guill Tool & Engineering Co., Inc., West Warwick, RI (US)

(21) Appl. No.: 19/271,893

(22) Filed: Jul. 17, 2025

Related U.S. Application Data
(60) Provisional application No. 63/672,747, filed on Jul. 18, 2024.

(51) Int. Cl. B29C 48/21; B29C 48/285

(52) U.S. Cl. CPC B29C 48/21; B29C 48/297

(57) ABSTRACT

An extrusion annular microlayer feedblock subassembly forming three or more annular layers comprising one or more input channels for each annular layer; two or more deflection channels an annular channel connected to each deflection channel and a culmination cavity

### FIELD

The present disclosure relates to extrusion die systems. In particular, the present disclosure relates to a modular die system containing multiple fluid pathways.

### BACKGROUND

Nanostructured materials are generally regarded as materials having very small grain feature size, typically in the range of approximately 1-100 nanometers (10\hat{ }−9 meters). Metals, ceramics, polymeric and composite materials may be processed in a variety of ways to form nanosized features. These materials have the potential for a wide range of applications, including for example, packaging, industrial, biomedical and electronic applications. As a result, a great deal of study is ongoing to gain a better understanding of the characteristics of these materials.

Conventional extrusion formed products are limited to approximately twelve layers. Microlayer extrusion processes can extend these limitations. Microlayer extrusion processes that provide methods for obtaining small grain features are described in U.S. Pat. No. 7,690,908, (hereinafter the “'908 Patent”), U.S. Pat. No. 9,381,712 (hereinafter the “'712 Patent”) and U.S. Pat. No. 10,836,089 (hereinafter the “089 Patent”) all of which are commonly owned by the assignee of the instant application, the disclosures of which are incorporated herein by reference in their entirety. Further examples of extrusion technology are described in U.S. Pat. Nos. 6,669,458, 6,533,565 and 6,945,764, also commonly owned by the assignee of the instant application, the disclosures of which are incorporated herein by reference in their entirety.

The typical nano or microlayer product is formed in a sheet. If a tubular product is desired, the microlayers are first formed into a sheet and then made into the tube in a post extrusion process. This creates a weld line or separation between the microlayers. The '908 Patent refers to a cyclical extrusion of materials by dividing, overlapping and laminating layers of flowing material, multiplying the flow and further dividing, overlapping and laminating the material flow to generate small grain features and improve properties of the formed product. Examples of the improved properties include, but are not limited to burst strength, tensile strength, tear resistance, barrier and optical properties. The '712 Patent refers to extruding a flow of extrusion material in a non-rotating extrusion assembly, forming a first set of multiple laminated flow streams from the extruded flow, amplifying a number of the laminations by repeatedly compressing, dividing and overlapping the multiple laminated flow streams, rejoining the parallel amplified laminated flows, forming a first combined laminate output with nano-sized features from the rejoining; and forming a tubular shaped microlayer product from the combined laminate output. Such products do not contain a so-called weld line, rather the weld is staggered and integrated into interdigitating layers of the laminate. An alternative approach would be to add layers one at a time to create the end product. This approach can be impractical due to the size and complexity of the necessary die. The '089 Patent refers to a multicomponent approach to standard and microlayer coextrusion. This defines a method for creating multicomponent multilayered products comprised of merging multiple side by side process streams where each process stream consists of one or more component sections. Each process stream of flow could undergo multiple manipulations and be derived from multiple other streams of material. Streams could be comprised of one to thousands of layers of materials in any orientation. The merging of these streams in stages defines the multicomponent approach. Each component section can include layering geometry that when joined together allow for numerous multiples of the individual component layer count. The newly microlayered forms would rejoin after passing through each component and proceed to be compressed into the desired product shape. This multicomponent approach allows for increased cleanability, flow tuneability and layer count modularity catering to the specific application.

Rather than using multiple components using traditional manufacturing techniques, it is desirable to produce a singular condensed component with, for example, advances in additive manufacturing using metallic inputs or stock unique geometries.

### SUMMARY

The benefits of the claimed subject matter are to provide a means of manufacturing microlayer products using an extrusion die comprised of one or more modular components or subassemblies which can create the desired microlayer structure. The design of these components or subassemblies would allow for each component/subassembly to produce and/or combine multiple layers. These layers can be produced in annular layers, flat layers or any profile shape and could be made of multiple materials in a mixture or bounded to regions of the layer. One exemplary embodiment component would have one or more input streams of material, which would be processed into multiple annular layers, recombined and then exit a singular output. Alternatively, each of these layers could exit from the component separately. These components could be modularized such that they can be stacked end to end. The outputs from each modular device could be the same or different. These differences could include total number of layers, layer material compositions, layer thicknesses, layer orientation, or stream components.

In one embodiment, an extrusion annular microlayer feedblock subassembly forming three or more annular layers is provided. The extrusion annular microlayer feedblock subassembly includes one or more input channels for each annular layer; two or more deflection channels connected to each input channel, the output of each deflection channel designed to produce a layer stream which merge at flow joints of layer streams from one or more adjacent deflection channels to form a merged annular flow stream; an annular channel connected to the two or more deflection channels designed to receive the merged annular flow stream; and a culmination cavity connected to the annular channel into which the merged annular flow stream from the annular channel is fed, wherein the extrusion annular microlayer feedblock subassembly includes at least three sets of the two or more deflection channels and the annular channel for each set of the two or more deflection channels wherein each of the three sets are laterally spaced along a central axis that lies along the length of the extrusion annular microlayer feedblock subassembly.

In another embodiment, a method of extrusion is provided. The method of extrusion includes using an extrusion annular microlayer feedblock subassembly forming three or more annular layers comprising one or more input channels for each annular layer; two or more deflection channels connected to each input channel, the output of each deflection channel designed to produce a layer stream which merge at flow joints of layer streams from one or more adjacent deflection channels to form a merged annular flow stream; an annular channel connected to the two or more deflection channels designed to receive the merged annular flow stream; and a culmination cavity connected to the annular channel into which the merged annular flow stream from the annular channel is fed, wherein the extrusion annular microlayer feedblock subassembly includes at least three sets of the two or more deflection channels and the annular channel for each set of the two or more deflection channels wherein each of the three sets are laterally spaced along a central axis that lies along the length of the extrusion annular microlayer feedblock subassembly; feeding input streams into the one or more input channels; passing the input streams through two or more deflection channels, each deflection channel producing a layer stream which merges at flow joints of flow streams from the one or more adjacent deflection channels to form a merged annular flow stream; passing the merged annular flow stream into the annular channel; and passing the merged annular flow stream from the annular channel into a culmination cavity.

In another embodiment, an extrusion die assembly is provided. The extrusion die assembly includes an extrusion annular microlayer feedblock subassembly includes one or more input channels for each annular layer; two or more deflection channels connected to each input channel, the output of each deflection channel designed to produce a layer stream which merge at flow joints of layer streams from one or more adjacent deflection channels to form a merged annular flow stream; an annular channel connected to the two or more deflection channels designed to receive the merged annular flow stream; and a culmination cavity connected to the annular channel into which the merged annular flow stream from the annular channel is fed, wherein the extrusion annular microlayer feedblock subassembly includes at least three sets of the two or more deflection channels and the annular channel for each set of the two or more deflection channels wherein each of the three sets are laterally spaced along a central axis that lies along the length of the extrusion annular microlayer feedblock subassembly.

In another embodiment, an extruded product including at least 3 annular layers is provided. The extruded product is made using a method of extrusion that includes using an extrusion annular microlayer feedblock subassembly forming three or more annular layers comprising one or more input channels for each annular layer; two or more deflection channels connected to each input channel, the output of each deflection channel designed to produce a layer stream which merge at flow joints of layer streams from one or more adjacent deflection channels to form a merged annular flow stream; an annular channel connected to each deflection channel designed to receive the merged annular flow stream; and a culmination cavity connected to the annular channel into which the merged annular flow stream from the annular channel is fed, wherein the extrusion annular microlayer feedblock subassembly includes at least three sets of the two or more deflection channels and the annular channel for each set of the two or more deflection channels wherein each of the three sets are laterally spaced along a central axis that lies along the length of the extrusion annular microlayer feedblock subassembly; feeding input streams into the one or more input channels; passing the input streams through two or more deflection channels, each deflection channel producing a layer stream which merges at flow joints of flow streams from the one or more adjacent deflection channels to form a merged annular flow stream; passing the merged annular flow stream into the annular channel; and passing the merged annular flow stream from the annular channel into a culmination cavity.

### DESCRIPTION OF THE DRAWINGS

The accompanying drawings illustrate presently preferred embodiments of the present disclosure, and together with the general description given above and the detailed description given below, serve to explain the principles of the present disclosure.

FIG. 1 is a perspective view of the flow through one embodiment of the present disclosure of an annular microlayer feedblock;

FIG. 2 is a cross-section view of the flow through the annular microlayer feedblock of the embodiment of FIG. 1;

FIG. 3 is a perspective view of the flow through another embodiment of the present disclosure of an annular microlayer feedblock with spiraled input channels;

FIG. 4 is a cross-section view of another embodiment of the present disclosure of cross-sectional flow within an annular microlayer feedblock with annular input streams;

FIG. 5 is a perspective rear view of the flow through another embodiment of the present disclosure of an annular Microlayer Feedblock with input channels that flow radially inwards;

FIG. 6 is a perspective front view of the flow through the embodiment of FIG. 5 of an annular microlayer feedblock;

FIG. 7 is a cross-sectional view of the flow through another embodiment of the present disclosure of two radially fed annular microlayer feedblocks;

FIG. 8 is a cross-sectional view of the flow through another embodiment of the present disclosure of an annular microlayer feedblock in which radial input channels progress to deflection channels in both directions;

FIG. 9 is a cross-sectional view of the flow through another embodiment of the present disclosure of a radially fed annular microlayer feedblock in which the radial input streams converge at a smaller radial position;

FIG. 10 is a cross-sectional view of the flow through another embodiment of the present disclosure of an annular microlayer feedblock in which input channels progress to deflection channels which feed a radial culmination cavity;

FIG. 11 is a front view of the flow through the embodiment of FIG. 10 of an annular microlayer feedblock in which input channels progress to deflection channels which feed a radial culmination cavity;

FIG. 12 is a perspective view of the flow through one embodiment of a layer multiplication device or element;

FIG. 13 is a perspective view of the flow through another embodiment of a layer multiplication device or element including compression in the flow direction;

FIG. 14 is a perspective view of the flow through another embodiment of a layer multiplication device or element including flow division prior to entering a deflection channel and fanning of the input channel back to its original flow shape;

FIG. 15 is a perspective view of the flow through another embodiment of a layer multiplication device or element including flow division prior to entering a deflection channel where fanning takes place perpendicular to the primary flow direction, reducing the flow length required;

FIG. 16 is a cross-sectional view of an embodiment of the present disclosure of an annular microlayer feedblock subassembly;

FIG. 17 is a cross-sectional view of another embodiment of the present disclosure of an annular microlayer feedblock subassembly;

FIG. 18 is a cross-sectional view of another embodiment of the present disclosure of an annular microlayer feedblock subassembly modularly aligned; and

FIGS. 19, 20A and 20B are a cross-sectional view of embodiments of the present disclosure of products produced by an annular microlayer feedblocks of the current disclosure in which layers contain single or multiple materials;

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Unless otherwise indicated, all numbers expressing quantities of ingredients, reaction conditions, and so forth used in the specification and claims are to be understood as being modified in all instances by the term “about” or “approximate.” Accordingly, unless indicated to the contrary, the numerical parameters set forth in this specification and attached claims are approximations that may vary depending upon the desired properties sought to be obtained by embodiments of the present disclosure. As used herein, “about” or “approximate” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

The terms “%”, “% by weight”, “weight %” and “wt %” are all intended to mean unless otherwise stated, percents by weight based upon a total weight of 100% end composition weight. Thus 10% by weight means that the component constitutes 10 wt. parts out of every 100 wt. parts of total composition.

The material to be input into the embodiments of the present disclosure (e.g., an input stream) can include a single material, a combination of different materials or a material having two or more layers of single materials (e.g., layer streams) and/or a combination of different materials (e.g., multicomponent layers).

The aspects of the present disclosure relate to extrusion annular layer feedblocks, and subassemblies, methods of using the extrusion die assemblies including the extrusion annular layer feedblocks and extrusion layer products that are produced including one or more input channels for each annular layer; two or more deflection channels connected to each input channel; an annular channel connected to the two or more deflection channels to receive a merged annular flow stream; and a culmination cavity connected to the annular channel into which the merged annular flow stream from the annular channel is fed. Another aspect of the present disclosure relate to extrusion annular layer feedblocks, and subassemblies, methods of using the extrusion die assemblies including the extrusion annular layer feedblocks and extrusion layer products that are produced including one or more input channels for each annular layer; one or more deflection channels connected to each input channel, where there is one deflection channel the output of each deflection channel designed to produce an annular layer stream which merge at a flow joint to form a merged annular flow stream or where there two or more deflection channels the output of each deflection channel designed to produce a partial annular layer stream which merge at flow joints from one or more adjacent deflection channels to form the merged annular flow stream; an annular channel connected to the one or more deflection channels to receive the merged annular flow stream; and a culmination cavity connected to the annular channel into which the merged annular flow stream from the annular channel is fed.

Aspects of the present disclosure include an annular layer feedblock which accepts input flow streams and creates multiple annular streams within a single die component or subassembly.

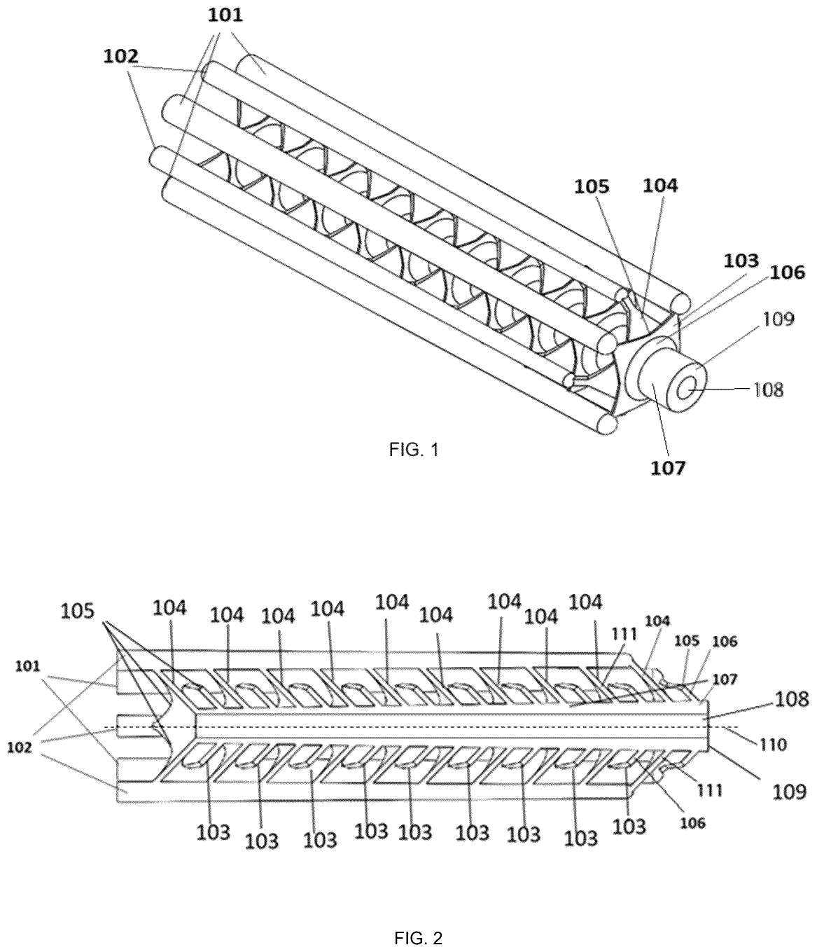

The embodiment of FIG. 1 includes one embodiment of the present disclosure that includes an annular microlayer feedblock and the flow of layer by layer of material forming such layers and creation which could occur in a singular die component annular microlayer feedblock. This figure shows the flow through the component creating a 20 layer output stream 109 on a substrate 108 in the culmination cavity 107. Variations of this embodiment include producing 3-5, 5-10, 10-20, or 20-100 or 100 to 1000s of annular layers in a single die component or subassembly. FIG. 2 is a cross-sectional view of this flow of the embodiment of FIG. 1. In this example there are 8 different input streams, but any number of input streams or channels may be present. There are four input streams or channels 101 that are used to form 10 of the layers of material flowing into input streams or channels 101 and four input streams or channels labeled 102 that are used to create the other 10 layers of material flowing into input streams or channels 102. There can be any number of input channels which can be composed of any number of materials. The grouping of input channels does not necessarily need to remain consistent. These input streams can have any cross-sectional shape such as round, flat, dog-boned or other profile shapes. These input streams or channels can change in geometry as they progress towards the final layers created in the component. The input channels can be fully enclosed or bounded by another die component. These input streams can be terminated within the die component or progress towards additional die components which could include another annular microlayer feedblock. As the input streams progress forward, additional material is deposited into downstream deflection channels 103 that are connected to input channel 101 and deflection channels 104 that are connected to input channel 102. Deflection channels 103 and 104 are duplicated on either side of the culmination cavity 107 on a substrate 108 in FIG. 2. As the deflection channels progress towards the culmination cavity 107, the four input flow streams from the deflection channels join together forming flow joints 105 where the flow streams from the 4 deflection channels for each input stream meet. Following this, the flow streams join at the flow joints to form a discrete annular layer that proceeds to an annular channel 106 for input channel 101 and annular channel 111 for input channel 102 before leaving the exit of the annular channel 106 or 111 and flowing into culmination cavity 107. Deflection and annular channels can be of different sizes and thicknesses and can change shape along their length. These layers are deposited one after the other into culmination cavity 107. This culmination cavity 107 can be wholly enclosed within the annular feedblock or be enclosed by separate die components and lies along a central axis 110 for the length of the culmination cavity 107. The culmination cavity 107 can change in shape, thickness or diameter as layers are being deposited. A change in cross-sectional shape of the annular channels 106 and 111 or culmination cavity 107 can be used to balance and adjust deposition rates from layer to layer. After all layers are deposited into the culmination cavity 107, the final culminated flow stream 109 can progress into other die components where additional layers could be added or the culminated flow stream is formed into the final extrusion shape. In the example shown in FIGS. 1 and 2, the groups of input channels 101 and 102 alternate in their deposition and only form discrete layers into the annular channels 106 and 111 in combination with streams from within their group. However, materials from any input stream could be used to make any layer and these layers do not need to be created in an alternating format.

The embodiment of FIGS. 1 and 2 includes 10 sets of four deflection channels 103 for input channels 101, each set with an annular channel 106 and 10 sets of four deflection channels 104 for input channels 102, each set with an annular channel 111. The embodiments of FIGS. 1 and 2 can include flow joints from one set of the at least three sets of two or more deflection channels that are offset relative to flow joints from another set of the at least three sets of two or more deflection channels.

The embodiment of FIG. 2 includes a cross-section view of the flow through an annular microlayer feedblock of FIG. 1 and shows the culmination cavity 107 beginning with the deposition of the first layer formed by merging flow originating from streams 102. The culmination cavity 107 could already be formed from other die components and contain other materials and layers. In this example the input streams 101 and 102 are shown at a diameter outside of the culmination cavity 107. These input streams could reside at a diameter inside the diameter of the culmination cavity 107 and be deposited outwards. The culmination cavity 107 could therefore be enclosed by two microlayer feedblocks in which layers are deposited from inside and outside the diameter of the culmination cavity. A single feedblock component could also accomplish this.

The streams of input channels 101 and 102 could also be split and create additional flow channels which are then fed into deflection channels 103 and 104, respectively. This can occur before or after material has already been deposited into other deflection channels. For example, shown streams of input channels 101 could have originated from a single input channel which was then split to form the four channels present in the example.

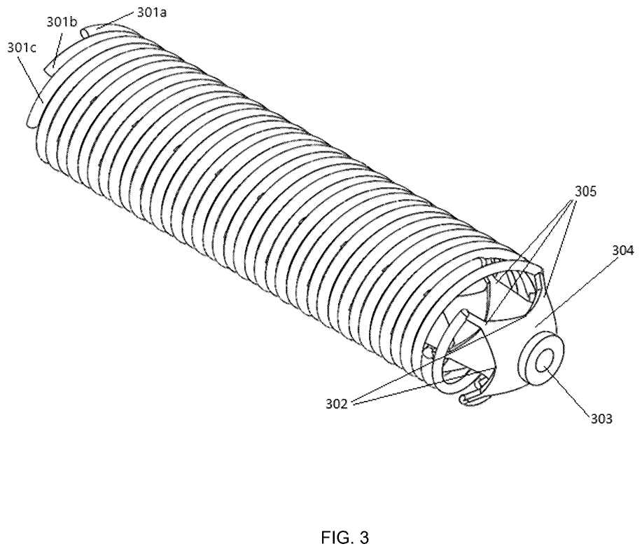

FIG. 3 illustrates another embodiment of the present disclosure that includes a plurality of input channels 301a, 301b and 301c, which are spiraled where channels split away from the spiraled input channels 301a, 301b and 301c to direct the flow toward each of the multiple deflection channels included in the embodiment. Deflection channels 305 are also shown in the figure while there are also multiple other deflection channels and annular channels in the embodiment covered by the spiraled input channels 301a, 301b and 301c with a similar configuration of deflection channels and annular channels to FIG. 2. This allows for flow joints at 302 to be dispersed around a central axis 303 from layer to layer, the central axis 303 extends the length of the embodiment. This arrangement can result in more uniform properties and increased strength of the final extrudate because flow joints can be an inherent weak spot and this would avoid aligning them through the wall thickness of an end product. Annular channels 304 can also include spiraled grooves which can be designed to disperse material present at the flow joints around the individual annular layer.

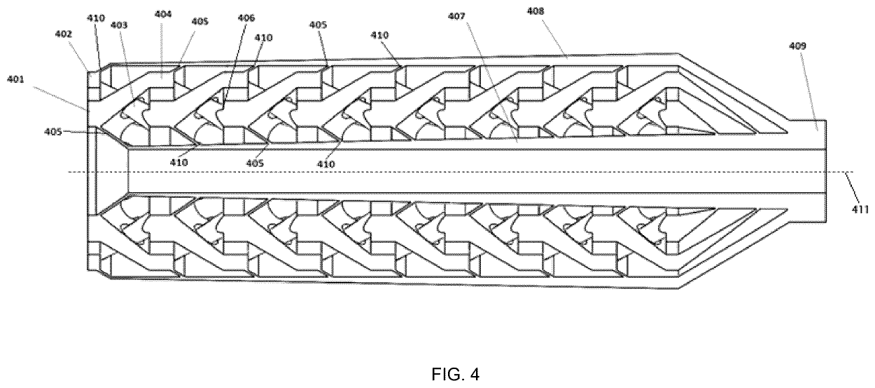

Another aspect of the present disclosure is using annular layers as input streams. These annular layers can be formed within or be fed into a single component. The embodiment of FIG. 4 illustrates a cross-section of how the flow would look within such a component. The embodiment of FIG. 4 is a cross-section of a three-dimensional embodiment that includes multiple sets of components included in FIG. 4. As annular input feeds 401 and 402 progress they weave past each other 403 to reform into annular rings 404 at flow joints 406 and deposit into one or more culmination cavities through deposition channels 405 for input feeds 401 and 410 for input feeds 402. FIG. 4 shows two culmination cavities, one at a smaller diameter 407 and one at a larger diameter 408 than the input feeds. The geometry of flows as the input streams weave past each other are not limited to that which is pictured where round flows 403 progress into round pathways through another other input feed. FIG. 4 also shows a final culmination cavity 409 into which flow from culmination cavities 407 and 408 merge. Final culmination cavity 409 lies along a central axis 411 for the length of the culmination cavity. As with previous examples, the culmination cavities can be wholly bound by the annular microlayer feedblock or be formed along with other die components.

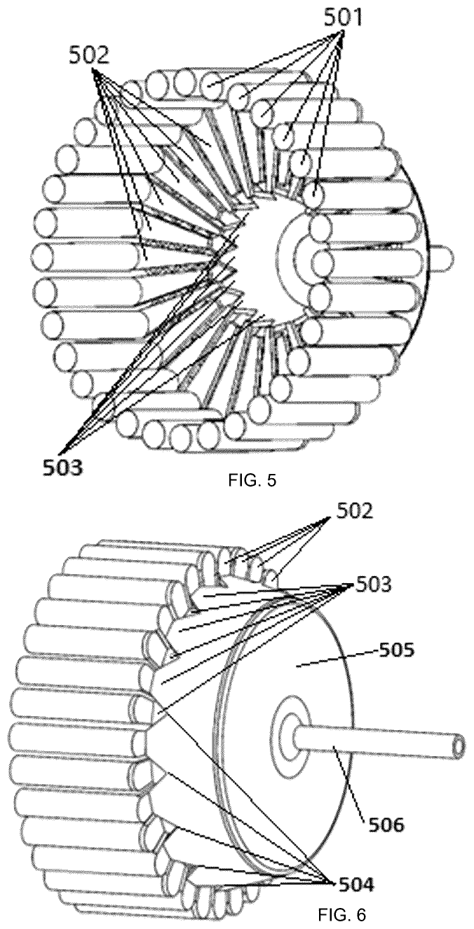

Another aspect of the present disclosure is an annular microlayer feedblock in which input channels flow radially inwards or outwards. The embodiment of FIG. 5 illustrates flow channels branching off primary flow channels 501 and flowing radially inwards through radial input channels 502 and then through deflection channels 503 to create annular layers at flow joints 504 and deposit into one or more culmination cavities 505 and into a final culmination cavity 506. FIGS. 5 and 6 show how the radial input channels 502 would feed deflection channels 503.

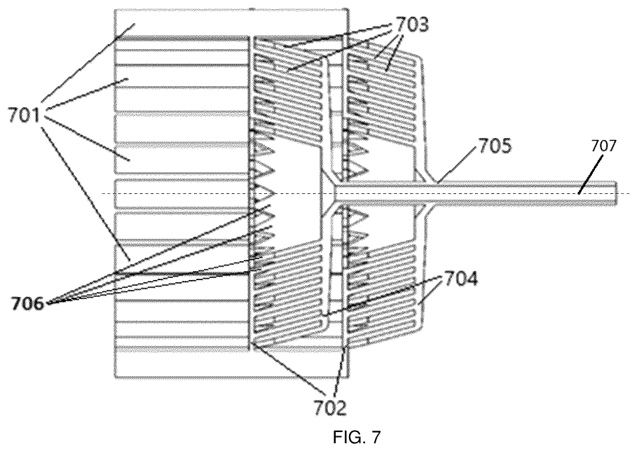

The embodiment of FIG. 7 illustrates a cross-section of how two annular radially fed microlayer feedblocks (each feedblock similar to the embodiments illustrated in FIGS. 5 and 6) could be arranged in sequence. They could share parent input channels 701 which would then branch into radial input channels 702. Each of these input channels then feed multiple sets of deflection channels 706 which would form individual annular layers. These individual annular layers would then progress via annular conduits 703 towards an annular culmination cavities 704. Deflection channels 706 and annular culmination cavities 704 are duplicated on either side of a central flow cavity 705. Central flow cavity 705 lies along a central axis 707 for the length of the central flow cavity 705. The flow from the first annular culmination cavity 704 in the first annular radially fed microlayer feedblock would progress forward towards and into the central flow cavity 705 forming a first layer therein and the first layer formed in the first radially fed microlayer feedblock in the central flow cavity 705 progress towards toward the second annular radially fed microlayer feedblock where the flow from the second annular culmination cavity 704 the second annular radially fed microlayer feedblock would progress toward and into the central flow cavity 705 forming a second layer on the first layer. The output flow from the culmination cavity of the second microlayer feedblock merges on top of the output flow from the first annular microlayer feedblock.

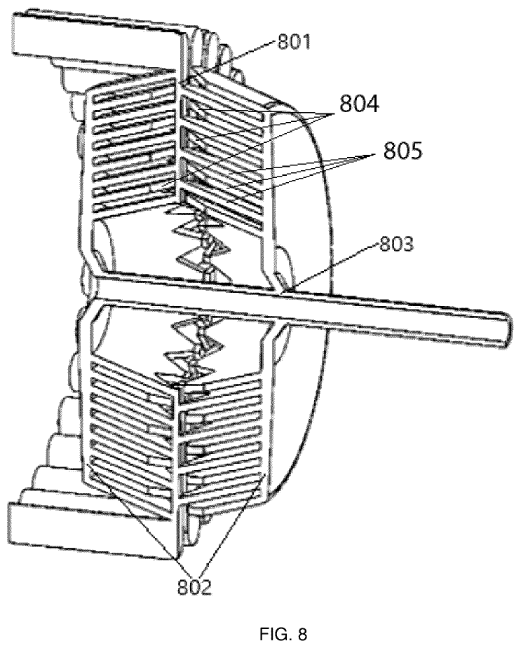

In The embodiment of FIG. 8 includes radial input channels 801 have deflection channels 804 and into which the annular layer formed proceeds into annular channels 805 on two sides which progress into two separate culmination cavities 802. The embodiment of FIG. 8 is a cross-section of a three-dimensional embodiment that includes multiple sets of components included in FIG. 8. Radial input channels 801 and culmination cavities 802 are duplicated on either side of a central cavity 803. The output of a first culmination cavity 802 progresses toward the central cavity 803 forming a layer therein and the output of a second culmination cavity 802 would merge on top of the layers formed from the first culmination cavity 802.

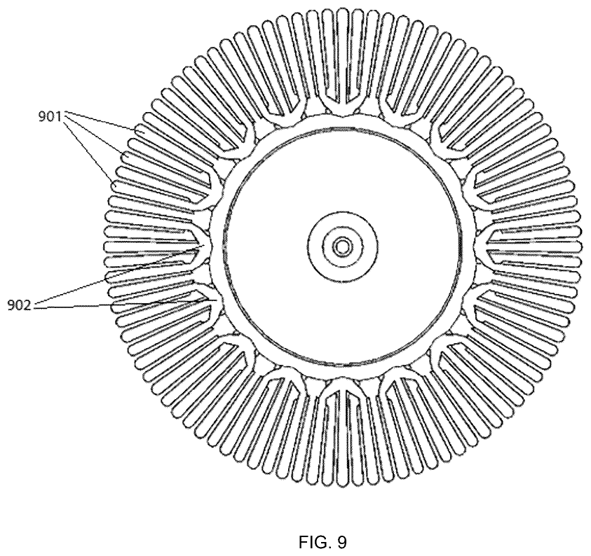

The embodiment of FIG. 9 illustrates how radial input streams 901 converge at 902. In this embodiment, deflection channels at larger diameters prior to convergence are omitted for visualization. This may be done so that the number of feeds can be reduced at a smaller diameter and allow for features large enough for machinability along with sufficient structural integrity of the component(s). More feeds reduce the need for fanning of material in deflection cavities which in turn allows for a more compact design but at smaller diameters the same number of feeds may be difficult to accommodate. The embodiment of FIG. 9 illustrates three radial input channels 901 converging at 902, but there could be more or less radial input channels. One set of radial input channels is set further back than the other set in order to allow for convergence without interference.

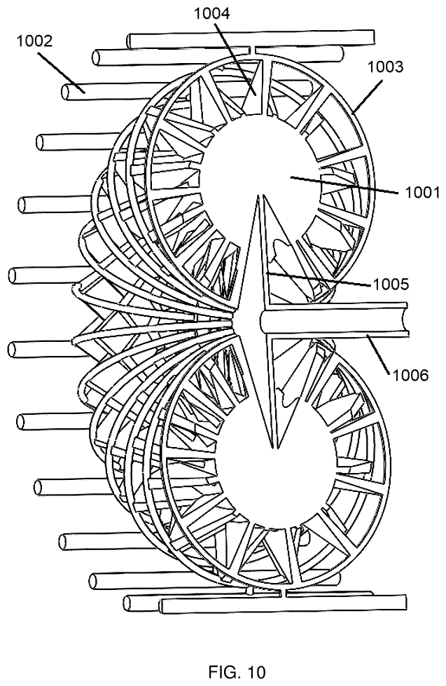

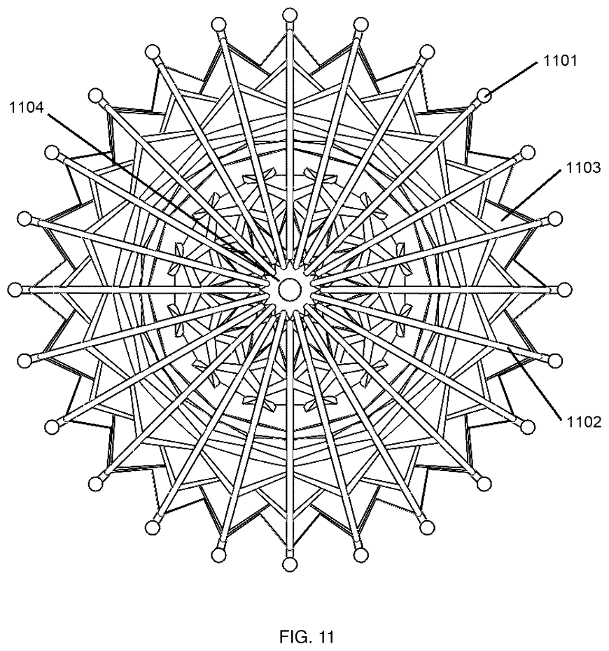

Another aspect of the present disclosure includes an annular microlayer feedblock in which the annular layers are radially deposited into a culmination cavity. An example of this is illustrated in FIGS. 10 and 11 in which a torus shaped culmination cavity 1001 is used to generate multiple annular layers. Material is fed through alternating overhead input channels 1002, 1101 delivering into circular flow passages 1003, 1102. A portion of each layer is deposited from the circular passages into fanning deflector channels 1004, 1103 forming continuous rings of flow that laminate with its neighboring layers in the torus culmination cavity 1001. The torus cavity's flow will progress to a central flow cavity 1005, and deposit to the inner bore 1104, 1006. Here the extrude can be further shaped or joined with additional streams.

Another aspect of to the present disclosure includes layer multiplication devices or elements that the flow of input channels can undergo as they progress to each layer formation element. Such multiplication elements can also be used in embodiments of the present disclosure to split (i.e., divide) flow streams as is included in several embodiments of the present disclosure.

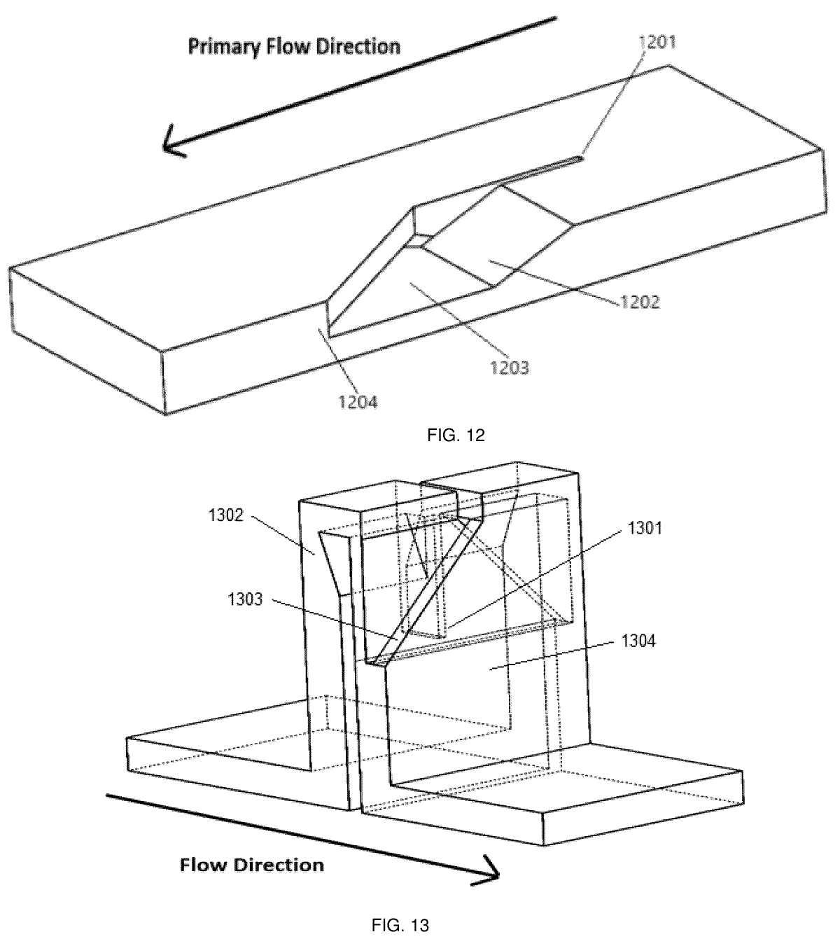

Between layers, multiplication or mixing elements may be used. These components can help disperse fillers or multiply layers. Some fillers or colorants may be predisposed to aggregate towards the wall of a flow. These elements may help to ensure more homogenous mixture. The embodiment of FIG. 12 illustrates an embodiment of a layer multiplication device or element in which flow, which can be single layer or multiple layers, is split 1201, compressed 1202, fanned 1203 and converged 1204. The embodiment of FIG. 13 illustrates a similar flow geometry comprised of flow, which can be single layer or multiple layers, being split 1301, compressed 1302, fanned 1303 and converged 1304 with the difference of the length of the element is compressed in the flow direction by doing some of the multiplication steps perpendicular to the primary flow direction. Other mixing elements such as static mixers and multiplication devices or elements designs such as those that perform a 4× multiplication of layers are envisioned to be useful as well.

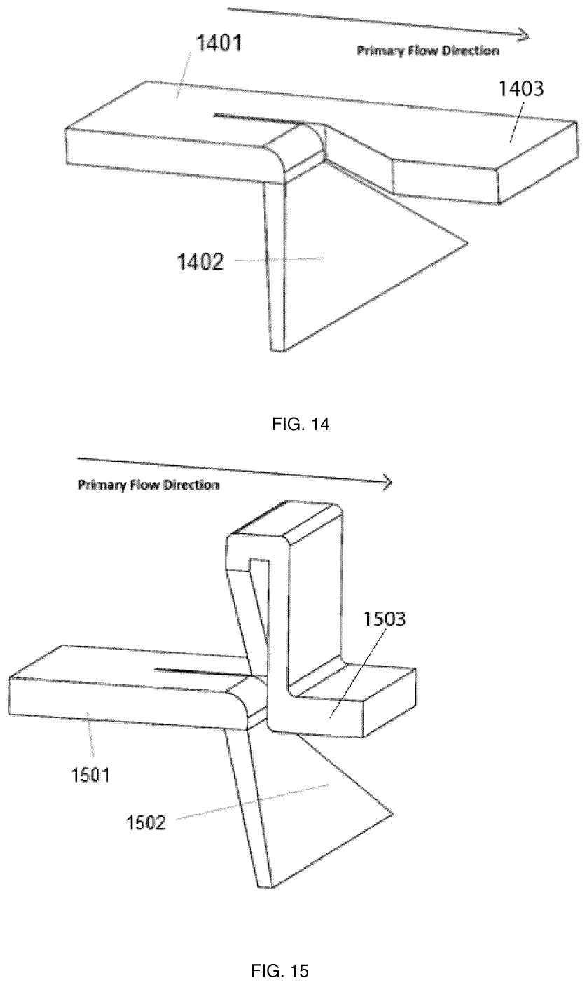

Other embodiments include those illustrated in FIGS. 14 and 15 in which prior to input streams 1401/1501 being deposited into deflection channels, a section of the input flow, which can be single layer or multiple layers, may first be divided from the remaining flow of the input channel 1403/1503. This is illustrated in the embodiments of FIGS. 14 and 15. This may be useful if the input channels contain a stream of layers. This method could split the channel through the layers, allowing layers to be deposited into a deflection channel 1402/1502. If the bottom of an input channel containing layers were passed into a deflection channel, only a bottom subset of layers would progress to a deflection channel. This flow geometry allows for the full layer structure to be deposited into a deflection channel. As shown, the remaining geometry of the input channel could fan back to its original shape in the same plane as shown in FIG. 14 or could fan in another direction to aid in the dispersion of flow joints as shown in FIG. 15 The flow designs of FIGS. 14 and 15 or similar geometries when applied to each layer formed in an annular microlayer feedblock, would allow for the number of layers present in an input stream to be multiplied and formed into annular layers.

Additionally, flow through input may be controlled using valves such as choke valves or adjustable mechanisms which can restrict or encourage flow through individual or sets of channels. These valves or mechanisms can be controlled through motorized components or systems such as those that are using a control system or be adjusted manually. Mechanisms to control flow to individual layers are also envisioned.

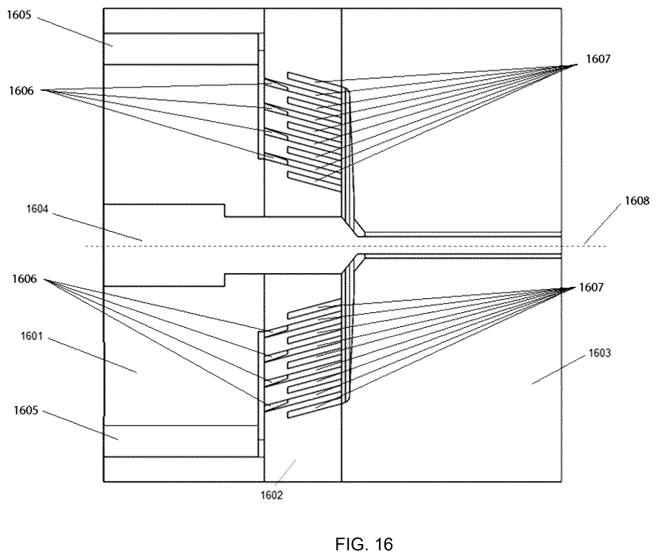

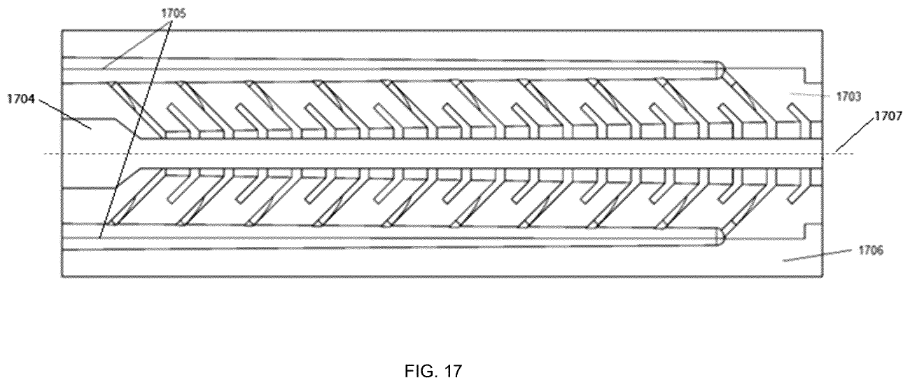

Variations of annular microlayer feedblock designs can be made within a singular component through processes such as 3D printing. Alternatively, these designs can be split into multiple components to form a microlayer feedblock sub assembly. The embodiment of FIG. 16 is a cross-section of a three-dimensional embodiment that includes multiple sets of components included in FIG. 16. The embodiment of FIG. 16 illustrates an example subassembly in which the annular microlayer feedblock is split into four components. In this example an input stream component 1601 on opposing sides of the figure contains input channels 1605 on opposing sides of the figure which progress towards deflection channels 1606 contained in a feedblock component 1602 and supplied via input channels 1605 on opposing sides of the figure. Deflection channels 1606 are each connected to a conduit 1607 producing an annular flow with opposing sides of the figure in a culmination component 1603. Each conduit 1607 then feeds into central core component 1604 of feedblock component 1602. Central core component 1604 lies along a central axis 1608 for the length of the central core component 1604. Variations of this feedblock component could be designed to create 3 to 1000s of annular layers or more specifically 3-5, 5-10, 10-20, or 20-100 or 100 to 1000s of annular layers. These layers could be fed by 1-100s of deflection channels each but more specifically 1 to 4, 4-8, 8-16, 16-32 or 32-100s of deflection channels. A feedblock component could be split into multiple components such as down the middle or in quadrants along the direction of the axis of a core component for manufacturing purposes. In this embodiment, the layers formed by the feedblock component 1602 proceed to a cavity formed by a culmination component 1603 which creates a culmination cavity along with the feedblock component 1602. Culmination component 1603 includes a core component 1604 which allows flow from the culmination component 1603 to proceed to the core component 1604 and in other examples or designs this component might also serve as a Culmination Cavity Component. An embodiment like this is illustrated in FIG. 17. The embodiment of FIG. 17 is a cross-section of a three-dimensional embodiment that includes multiple sets of components included in FIG. 17. Variations of the core component 1704 can contain a hollow inner diameter which could allow for a substrate to pass through for jacketing applications or air to pass through for tubing or blow molding applications. Core component 1704 lies along a central axis 1707 for the length of the core component 1704. FIG. 17 also illustrates an embodiment similar to the embodiment of FIG. 2 with input channels, which would allow for the flow input streams 1705, and are split between two components 1703 and 1706.

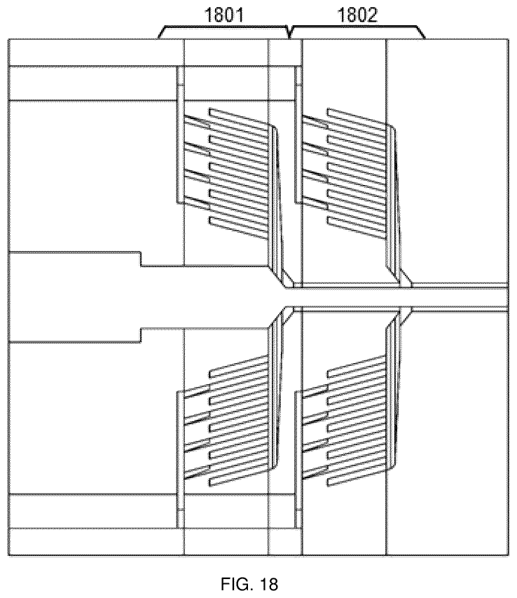

The embodiment of FIG. 18 illustrates an example of how two subassemblies (each similar to the embodiment of FIG. 16) could be positioned and constructed such that their outputs join along a central core. The embodiment of FIG. 18 is a cross-section of a three-dimensional embodiment that includes multiple sets of components included in FIG. 18. In this example the central core is shared, the component is part of the culmination cavity of the first subassembly 1801 and also serves as an input stream component for the second subassembly 1802. A cavity partly formed by the central core also may begin before any annular microlayer feedblock components and the cavity could contain materials which would form inner layers of a final extrudate.

Embodiments of the present disclosure can be integrated into a variety of extrusion die assembly form factors. These form factors include: die assemblies for extrusion lines creating tubular products such as hoses, tubes or pipes; die assemblies for extrusion lines creating rods or filaments; die assemblies for jacketing such as wires or cable; die assemblies for blow molding or blown films. Another use case could be the integration of an annular microlayer feedblock into 3D printing hot ends or output nozzles. Additionally, embodiments of the present disclosure can be used in an assembly which could line the inside of pipes with an extruded output. This could be done in such a way that a die assembly fed by an extruder or by some other feedstock is inserted into the diameter of a tube or pipe and the annular extruded output would lay onto the interior surface of a tube or pipe. Die assemblies including embodiments of the present disclosure can also utilize rotary components including rotary dies and rotary tips which could spin components of the die assembly on the interior or exterior of flow passages or culmination cavities. Additionally, assemblies utilizing embodiments of the present disclosure can include reciprocating components which could be used to change layer configurations or cross-sectional shapes along the length of extruded products. Striping components can also be used with embodiments of the present disclosure to deposit a stripe of material into the output. Thermal barriers such as insulating materials or air/vacuum voids between components or individual layer generating features of embodiments of the present disclosure can be used when materials of different processing temperature are processed together. Embodiments of the present disclosure can include an inner layer of polymer that is joined with the output layers of the annular microlayer feedblock, outer layer of polymer that is joined with the output of the annular microlayer feedblock and/or actuated tooling downstream of the output of the annular microlayer feedblock to dynamically change the output shape.

Annular microlayer feedblock embodiments of the present disclosure could also be used in a die assembly which contains components to multiply the number of annular layers through folding or by a splitting and stacking approach. Additionally, feed paths to the annular microlayer feedblock may contain valves to control the flow to certain regions of the feedblock, including the ability to alter layer gradients and/or enable/disable certain layers. Components could also be integrated to allow for the automation of these flow control valves via the use of servo, motors, and actuators. The microlayer feedblock may also be designed to permit multiple outputs, such as the ability to output multiple tubes.

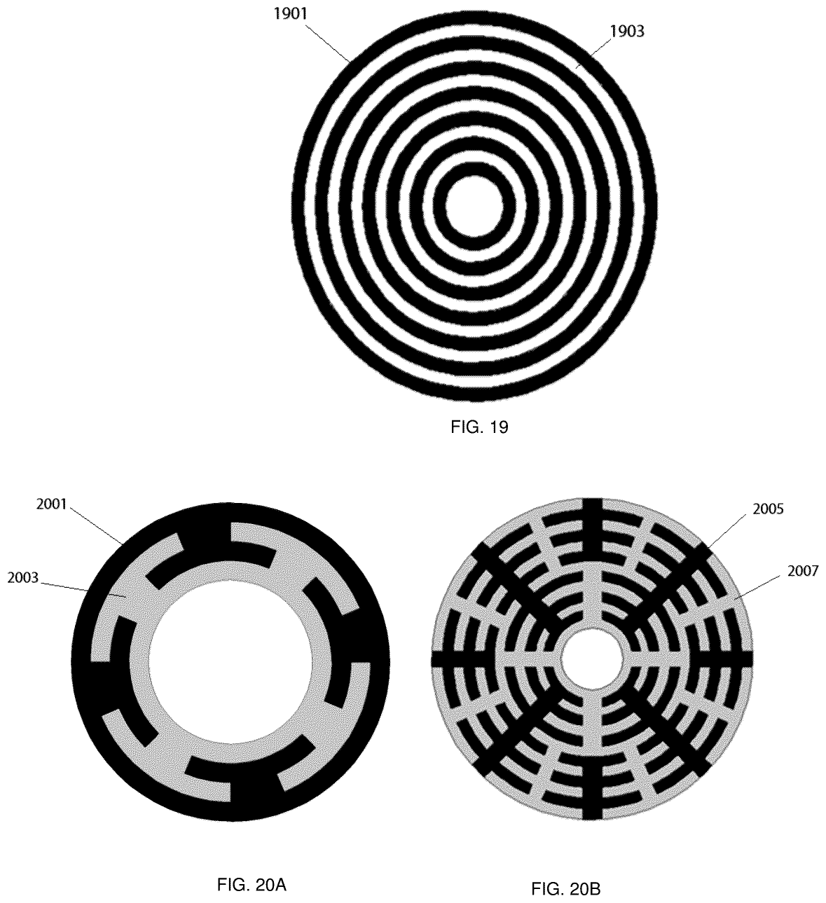

Another aspect of the present disclosure includes products which could be made by annular microlayer feedblocks of the present disclosure. Such product embodiments can include a tubular, rod or profile shape. The layers formed could contain individual layers comprising a singular composition such as the layers present in the embodiment illustrated in FIG. 19 that can include different layer sections 1901 and 1903 or be made of multiple materials such as layers present in the embodiments illustrated in FIG. 20A that can include different layer sections 2001 and 2003 and FIG. 20B that can include different layer sections 2005 and 2007.

FIGS. 20A and 20B show an additional form factor of products which could be created using an annular microlayer feedblock embodiment of the present disclosure. A product with annular layers which are made of different compositions around the layer can be used to mechanically interlock materials which would normally be incompatible. This approach could eliminate the need for materials or layers known as tie layers which are used to adhere two materials together. The embodiments in FIGS. 19, 20A and 20B show products containing two different materials. Other products could use more than two different materials. Additionally, products could contain outer and/or inner layers which could be produced by other die components which may include another annular microlayer feedblock processing the same or different materials. Additionally, products containing stripes embedded into or deposited onto the output flow of an annular microlayer feedblock subassembly or flow of an inner or outer layer are envisioned.

Embodiments of the present disclosure also include methods of use of embodiments of the present disclosure of extrusion annular layer feedblocks and subassemblies.

Embodiments of the present disclosure also include extrusion die assemblies including embodiments of the present disclosure of extrusion annular layer feedblocks and subassemblies.

Embodiments of the present disclosure also include products produced using embodiments of the present disclosure of extrusion annular layer feedblocks and subassemblies.

Additionally, geometries that are non-annular could be created by depositing annular layers into a culmination cavity that is not round such as one that is profile or flat or by depositing layers into a culmination cavity that transitions to a flat or profile shape further in the die.

Products comprising many thin polymeric layers have been shown to exhibit different material properties than those comprising a few or singular bulk layers. Some of the mechanisms that drive these changes in material properties include: a change in crystalline morphology of materials such as confined crystallization, molecular interaction of materials at the boundary of different layers such as those that can result in reduced crack propagations; forced assembly of filler particles such that the alignment, disbursement and orientation of particles are changed; and shear history of material molecules such that they arrange differently in a final extruded product. Material properties that can be tailored include: barrier properties of the transmission of gasses such as water vapor, oxygen, hydrogen, helium and gasses emitted by fuels; mechanical properties such as tensile strength, Young's modulus, and elongation at break, burst pressure, bend radius, fatigue resistance, crack propagation resistance, compressibility; electrical properties such as conductivity, dielectric strength, partial discharge resistance, and EMI shielding; and optical properties such as reflecting selective wavelengths through Bragg reflection of layers containing differing refractive indexes at ¼ wavelength layer thicknesses; thermal properties such as thermal conductivity and flame retardancy, magnetic properties, corrosion resistance and solubility. Due to the fundamental nature of polymers and the impact of microlayering, all material properties can be tailored, the list presented here is for example only and non-exhaustive.

Specific polymers envisioned being tailored with the embodiments of and in the present disclosure include: ABS (Acrylonitrile butadiene styrene), Acrylic, EPDM, ETFE (Ethylene Tetrafluoroethylene), EVA (Ethylene vinyl acetate), EVOH (Ethylene vinyl alcohol), FEP (Fluorinated ethylene propylene), FPVC (Flexible polyvinyl chloride), HDPE (High density polyethylene), LDPE (Low density polyethylene), LLDPE (Linear low density polyethylene), PA (nylon, polyamide), PC (Polycarbonate), PEBA (Polyether block amide), PEEK (Polyether ether ketone), PET (Polyethylene terephthalate), PETg (Polyethylene terephthalate glycol), PLA (Polylactic Acid), PLDL (Co-polymer of 1-lactide and dl-lactide), PMMA (Polymethyl methacrylate), PO (Polyolefin), PS (Polystyrene), PP (Polypropylene), PPS (Polyphenylene sulfide), PVA (Polyvinyl alcohol), PVDF (Polyvinylidene fluoride), RPVC (Rigid polyvinyl chloride), Rubber, Silicone, TPV (thermoplastic vulcanizates), TPO (Thermoplastic olefin), TPU (Thermoplastic polyurethane), XLPE/PEX (Cross Linked polyethylene), Polyethylene (LDPE,LLDPE,HDPE, XLPE), Liquid Crystal Polymers. This list is non-exhaustive and will generally apply to amorphous, crystalline, and semi-crystalline polymers. Generally, virtually all fluids can be processed with this technology, including thermoplastics, thermosets, self-healing polymers, UV cured polymers, photovoltaic polymers, raw ingredients for extrusion of edible products, concrete and molten metals such as aluminum and steel.

Specific examples of filler materials that can be included in embodiments of and in the present disclosure whose use can be enhanced include metallic flakes, mica, graphene, graphene oxide, graphite, carbon fibers, carbon nanotubes, carbon black, other carbon allotropes, glass fibers, clays, nano-clays such as bentonite and hectorite, nanocellulose, and wood.

Product categories that can be included in embodiments of and in the present disclosure envisioned include wire and cables, electrical insulation materials, fuel lines, gas lines, irrigation hoses, irrigation tubes, medical tubing, stents, catheters, pharmaceutical pills, drug reservoir systems, implantable medical devices, 3D printing filaments, shrink tubing, optical devices, batteries, and capacitors.

The following are more specific product constructions that can be included in embodiments of and in the present disclosure envisioned.

Microlayering PVC, an amorphous polymer, has been shown to improve tensile strength compared to a bulk wall of the same geometry. PVC is commonly used for medical tubing such as oxygen tubes and peristaltic tubes, plumbing pipes and as jackets for wires and cables. A microlayered version of these products containing multiple annular layers of PVC could help to improve performance of end products such as burst strength, kink resistance or crush resistance. This may allow for less material to be used to achieve the desired specification.

EVOH is a material commonly used for its barrier properties. However, it is relatively brittle and cracks through layers of EVOH after twisting or bending which can lead to a reduction of barrier properties. A product containing alternating annular microlayers of EVOH and a more ductile material could help reduce crack propagation and allow for enhanced fatigue resistance of barrier properties.

The orienting effects of microlayer techniques of fillers have great potential to enhance barrier properties. Graphene Oxide and Nanoclays have been shown to improve barrier properties particularly when oriented such that they form a tortuous path for permeates. Products containing annular microlayers filled with these fillers could be useful in containers, fuel lines, hydrogen hoses or liners.

The microlayer extrusion orienting mechanism can also be used to align mica flakes which could greatly enhance insulating properties in wire insulation and insulating components. These flakes could help to reduce partial discharge or treeing which is a major failure mechanism in wires and cables at medium or high voltages. Alternating materials could also help to act as a mechanism to stop the propagation of this failure mode through the wall thickness of insulating materials.

Time release pills or implantable medical devices containing one or more pharmaceuticals in an annular microlayered form factor could be made via an annular microlayer feedblock. The layer structure and loading of pharmaceuticals present in the individual layers can enable a wider range of time release profiles into a body.

Microlayering can be implemented in the formulation of filled polymer feedstock. Accuracy of desired filler loading can be improved with microlayering, the shear forces applied force the filler to take a highly specified geometry, permitting a higher predictability of filler to polymer ratio. A similar methodology could be conducted to alter the amount of loading of preexisting filled feedstock. Microlayering a pre-existing composite feedstock with pure polymer to reduce the filler percentage or layering with a feedstock of another composite to create an entirely new blend.

This written description uses examples as part of the disclosure, including the best mode, and also to enable any person skilled in the art to practice the disclosed implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While there have been shown, described and pointed out, fundamental features of the present disclosure as applied to the exemplary embodiments thereof, it will be understood that various omissions and substitutions and changes in the form and details of compositions, devices and methods illustrated, and in their operation, may be made by those skilled in the art without departing from the spirit or scope of the present disclosure. Moreover, it is expressly intended that all combinations of those elements and/or method steps, which perform substantially the same function in substantially the same way to achieve the same results, are within the scope of the present disclosure. Moreover, it should be recognized that structures and/or elements and/or method steps shown and/or described in connection with any disclosed form or embodiment of the present disclosure may be incorporated in any other disclosed or described or suggested form or embodiment as a general matter of design choice. It is the intention, therefore, to be limited only as indicated by the scope of the claims appended hereto.

1. An extrusion annular microlayer feedblock subassembly forming three or more annular layers comprising one or more input channels for each annular layer; two or more deflection channels connected to each input channel, the output of each deflection channel designed to produce a layer stream which merge at flow joints of layer streams from one or more adjacent deflection channels to form a merged annular flow stream; an annular channel connected to the two or more deflection channels designed to receive the merged annular flow stream; and a culmination cavity connected to the annular channel into which the merged annular flow stream from which the annular channel is fed, wherein the extrusion annular microlayer feedblock subassembly includes at least three sets of the two or more deflection channels and the annular channel for each set of the two or more deflection channels.

2. An extrusion annular microlayer feedblock subassembly according to claim 1, wherein each of the three or more annular channels are laterally spaced along a central axis that lies along the length of the extrusion annular microlayer feedblock subassembly.

3. An extrusion annular microlayer feedblock subassembly according to claim 1, wherein each of the three or more annular channels are radially spaced and deposited into a culmination cavity.

4. The extrusion annular microlayer feedblock subassembly according to claim 1 in which a singular extrusion annular microlayer feedblock subassembly is split along the central axis that lies along the length of the culmination cavity.

5. The extrusion annular microlayer feedblock subassembly according to claim 1, wherein the extrusion annular microlayer feedblock is a first extrusion annular microlayer feedblock subassembly and further including another extrusion annular microlayer feedblock is a second extrusion annular microlayer feedblock subassembly which receives a multilayer output of the first extrusion annular microlayer feedblock subassembly as an input and wherein additional layers are added by the second extrusion annular microlayer feedblock subassembly to the multilayer output of the first extrusion annular microlayer feedblock subassembly.

6. The extrusion annular microlayer feedblock subassembly according to claim 1 wherein the flow through the input channels or the layer streams can be adjusted.

7. The extrusion annular microlayer feedblock subassembly according to claim 1 further including a valve to adjust the flow through the input channels or the layer streams.

8. The extrusion annular microlayer feedblock subassembly according to claim 1 further including a motorized system or component to adjust the flow through the input channels or the layer streams.

9. The extrusion annular microlayer feedblock subassembly according to claim 1 further including at least one thermal barrier.

10. The extrusion annular microlayer feedblock subassembly according to claim 1 further including a layer multiplication device wherein a first input channel is connected to a secondary input channel through the layer multiplication device.

11. The extrusion annular microlayer feedblock subassembly according to claim 1 wherein the one or more input channels spiral around the extrusion annular microlayer feedblock subassembly.

12. The extrusion annular microlayer feedblock subassembly according to claim 1 wherein the flow joints from one set of the at least three sets of two or more deflection channels are offset relative to flow joints from another set of the at least three sets of two or more deflection channels.

13. The extrusion annular microlayer feedblock subassembly according to claim 1 wherein extrusion annular microlayer feedblock subassembly outputs layers are of substantially equal layer thickness.

14. The extrusion annular microlayer feedblock subassembly according to claim 1 wherein extrusion annular microlayer feedblock subassembly outputs layers are of substantially varying layer thickness.

15. The extrusion annular microlayer feedblock subassembly according to claim 1 wherein the extrusion annular microlayer feedblock subassembly outputs flat layers.

16. The extrusion annular microlayer feedblock subassembly according to claim 1 wherein the extrusion annular microlayer feedblock subassembly outputs annular layers.

17. The extrusion annular microlayer feedblock subassembly according to claim 1 wherein the extrusion annular microlayer feedblock subassembly outputs profile shape layers.

18. The extrusion annular microlayer feedblock subassembly according to claim 1 wherein the extrusion annular microlayer feedblock subassembly outputs multicomponent layer streams.

19. The extrusion annular microlayer feedblock subassembly according to claim 1 further including a substrate passage to permit the passage of a substrate through the extrusion annular microlayer feedblock subassembly.

20. The extrusion annular microlayer feedblock subassembly according to claim 1 further including a rotary die component.
